(19) United States
(12) Patent Application Publication
(10) Pub. No.: US 2007/0216283 A1
(43) Pub. Date: Sep. 20, 2007

(54) Image display apparatus

(75) Inventors: Toshiaki Kusunoki, Tokorozawa (JP); Etsuko Nishimura, Hitachiota (JP); Masakazu Sagawa, Inagi (JP); Kazutaka Tsuji, Hachioji (JP); Mitsuharu Ikeda, Kokubunji (JP)

Correspondence Address: MILES & STOCKBRIDGE PC, 1751 PINNACLE DRIVE, SUITE 500, MCLEAN, VA, 22102-3833, US

(73) Assignee: Hitachi Displays, Ltd.

(21) Appl. No.: 11/656,487

(22) Filed: Jan. 23, 2007

(30) Foreign Application Priority Data
Mar. 14, 2006 (JP) 2006-068467

(51) Int. Cl. H01J 63/04; H01J 1/62

(52) U.S. Cl. 313/495; 313/506; 257/40; 313/509

(57) ABSTRACT

A simple method was needed for dividing up the electron emitter electrodes into individual supply electrodes. An insulator partition wall was formed on the same layer and parallel to the supply electrode for supplying power to the electron emitter electrode, an electron emitter electrodes formed across the entire surface of the image display area, a side surface of the partition wall was sliced, condensation and solubility diffusion performed by heat treatment, ablation performed by irradiating the upper surface of the silicon partition wall with a laser, Joule thermal sealing/cutting performed by conducting electricity across the scanning lines enclosing the silicon partition wall in order to slice the electron emitter electrode.

### CLAIM OF PRIORITY

The present application claims priority from Japanese application JP 2006-068467 filed on Mar. 14, 2006, the content of which is hereby incorporated by reference into this application.

### FIELD OF THE INVENTION

The present invention relates to an image display apparatus and a manufacturing method for that image display apparatus, and relates in particular to an image display apparatus referred to as a flat panel display for self-light emission utilizing an electron source (field emitter) array.

### BACKGROUND OF THE INVENTION

Image display apparatus (field emission display: FED) utilizing electron sources that are tiny and capable of circuit integration are being developed. Electron sources for this type of image display apparatus are grouped into field emission display electron sources and hot electron type electron sources. Sources such as Spindt type electron type sources, surface conduction type electron sources, and carbon nanotube type electron sources belong to the former type (FED electron source), while sources such as MIM (Metal-Insulator-Metal) types of metal, insulator, and metal laminations, MIS (Metal-Insulator-Semiconductor) types of metal, insulation, and semiconductor laminations, and thin film electron sources of metal, insulator, semiconductor, and metal belong to the latter (hot electron) type.

The MIM type technology for example disclosed in JP-A No. 65710/1995 includes the MOS type (j. Vac. Sci. Technology, B 11(2) pp. 429-432 (1993)) for Metal-Insulator-Semiconductor types; the HEED type (such as recorded in High-efficiency-electro-emission device, Jpn, j, Appl, Phys, vol. 36, p. 939), the EL (electroluminescent) type (such as recorded in Electroluminescence, Applied Physics vol. 63, No. 6, page 592), and the porous silicon type (such as recorded in Applied Physics vol. 66, No. 5, page 437) for Metal-Insulator-Semiconductor-Metal types, etc.

The MIM type electron source is disclosed for example in JP-A No. 153979/1998. The structure and operation of the MIM type electron source are described as follows. Namely, the structure includes an insulation layer interposed between the upper electrode and the lower electrode, and by applying a voltage across the upper electrode and the lower electrode, electrons in the vicinity of the Fermi level in the lower electrode transmit through the barrier due to a tunnel effect, and electrons are injected into the insulation layer conduction band serving as the electron accelerating layer to become hot electrons, and flow into the conduction band of the upper electrode. Electrons among these hot electrons that possess an energy equal or higher than the work function φ of the upper electrode and that reach the upper electrode surface are emitted into the vacuum.

### SUMMARY OF THE INVENTION

These types of electron sources can be arrayed in multiple columns (for example, horizontally) and multiple rows (for example, vertically) to form a matrix, and an image display device then made from numerous fluorescent elements arrayed to match the individual electron sources. Photolithographic(resist) processes are preferably not used when manufacturing the electron emitter electrode since these types of electron sources are not prone to emit electrons if there is any surface contamination on the electron emitter electrode. An undercut is therefore formed on the side wall of the supply electrode side of the electron emitter electrode, or an undercut formed on the opening on the electron emitter section of the surface protective insulator film. During forming of the emitter electrode film, the fact that there is no mask or film formed on the undercut section is utilized to cut the electrode emitter via self alignment. Electrical isolation can be performed but requires a complicated process that causes higher processing costs.

The undercut formed on the supply electrode side wall is prone to electrical shorts if there are foreign objects present which results in a drop in production. Moreover, there is generally also a high amount of stress on the insulation film so that forming an undercut beneath the insulation film causes the insulation film overhang to collapse and leads to electrical shorts.

Resolving these problems, requires simplifying the structure and process for isolating the pixels, eliminating photo (resist) processes, improving the processing, preventing a drop in production due to foreign objects, and correcting electrical short defect locations.

A first object of the present invention is to provide a new technique for processing the electron emitter electrode, and an electron source structure to allow performing that new technique.

An effective technique for achieving the above objective is forming insulated partition walls between the supply electrodes on the electron emitter electrode of the field emitter array, that are parallel and in the same layer as the supply electrode.

Non-doped silicon, SiN (silcon-nitrogen) and inert doped silicon are effective as the insulated partition walls.

The electron emitter electrode is cut by utilizing the steep step in the side wall of the insulated partition wall. Condensing the partition wall surface by heat treatment, or solubility diffusion of the partition wall interior, thermal cutting/sealing by applying power to the overhanging partition wall of the electron emitter electrode, or trimming by ablation via laser irradiation onto the emitter electrode on the partition wall are effective methods for cutting the electron emitter electrode.

### BRIEF DESCRIPTION OF THE DRAWINGS

FIG. 1 is a plane view drawing showing an example of the image display apparatus utilizing an MIM type thin film electron source of this invention;

FIG. 2 is a drawing illustrating the operating principle of the thin film electron source;

FIG. 3 is a drawing showing the method for manufacturing the thin film electron source for the first embodiment of this invention;

FIG. 4 is a drawing showing a continuation of the method in FIG. 3 for manufacturing the thin film electron source of this invention;

FIG. 5 is a drawing showing a continuation of the method in FIG. 4 for manufacturing the thin film electron source of this invention;

FIG. 6 is a drawing showing a continuation of the method in FIG. 5 for manufacturing the thin film electron source of this invention;

FIG. 7 is a drawing showing a continuation of the method in FIG. 6 for manufacturing the thin film electron source of this invention;

FIG. 8 is a drawing showing a continuation of the method in FIG. 7 for manufacturing the thin film electron source of this invention;

FIG. 9 is a drawing showing a continuation of the method in FIG. 8 for manufacturing the thin film electron source of this invention;

FIG. 10 is a drawing showing conditions for dry etching of partition walls in the thin film type electron source of this invention;

FIG. 11 is a continuation of FIG. 10 showing the method for manufacturing the thin film type electron source of this invention;

FIG. 12 is a continuation of FIG. 11 showing the method for manufacturing the thin film type electron source of this invention;

FIG. 13 is a continuation of FIG. 12 showing the method for manufacturing the thin film type electron source of this invention;

FIG. 14 is a drawing showing the resistance across the scanning lines of the thin film type electron source of this invention;

FIG. 15 is a continuation of FIG. 14 showing the method for manufacturing the thin film type electron source of this invention;

FIG. 16 is a drawing showing resistance across the scanning lines isolated by heating solubility in this invention;

FIG. 17 is drawings showing the method for isolation by laser irradiation in this invention;

FIG. 18 is a drawing showing the method for isolating by conducting electricity across the scanning lines of this invention;

FIG. 19 is a drawing showing another example of the positional relation between the scanning electrode and the partition wall of this invention;

FIG. 20 is a drawing showing another example of the positional relation between the scanning electrode and the partition wall of this invention;

FIG. 21 is a drawing showing another example of the positional relation between the scanning electrode and the partition wall of this invention.

### DETAILED DESCRIPTION OF THE EMBODIMENTS

The preferred embodiments of this invention are described next while referring to the accompanying drawings. The description here utilizes the MIM type electron source as an example of an image display apparatus. However, this invention is not limited to MIM type electron sources and may be applied in the same way to image display apparatus using different types of electron emitter elements. The invention is particularly effective on hot electron type electron emitter electrodes for discharging only a portion of the element current into the vacuum.

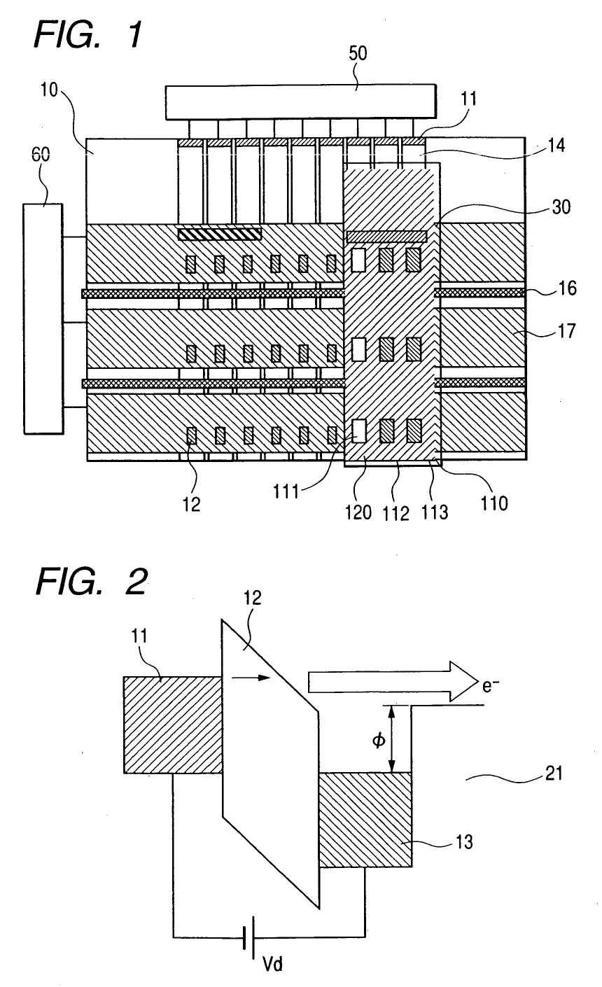

FIG. 1 is a drawing for describing the first embodiment of this invention. FIG. 1 is a planar (flat) view showing an example of an image display device utilizing an MIM thin film electron source. FIG. 1 shows the planar surface of one substrate (cathode substrate) 10 mainly serving as the electron source. The other substrate (fluorescent element substrate, display side substrate, color filter substrate) 110 forming a portion of the fluorescent element shows only sections of the black matrix 120 and fluorescent elements 111, 112, 113 in that inner surface.

The cathode substrate 10 contains a lower electrode 11 that forms the signal line (data line) connecting to the signal line drive circuit 50, a scanning electrode 21 connected to the scanning drive circuit 60 and installed perpendicular to the signal line, and other functional films described later on. The cathode (electron emitter section) is formed from an upper electrode 13 within the scanning electrode and laminated on a lower electrode 11 via an insulation layer 12. The cathode emits electrons from the insulation layer (tunnel insulation layer) 12 formed on a thin layer section of the insulation layer.

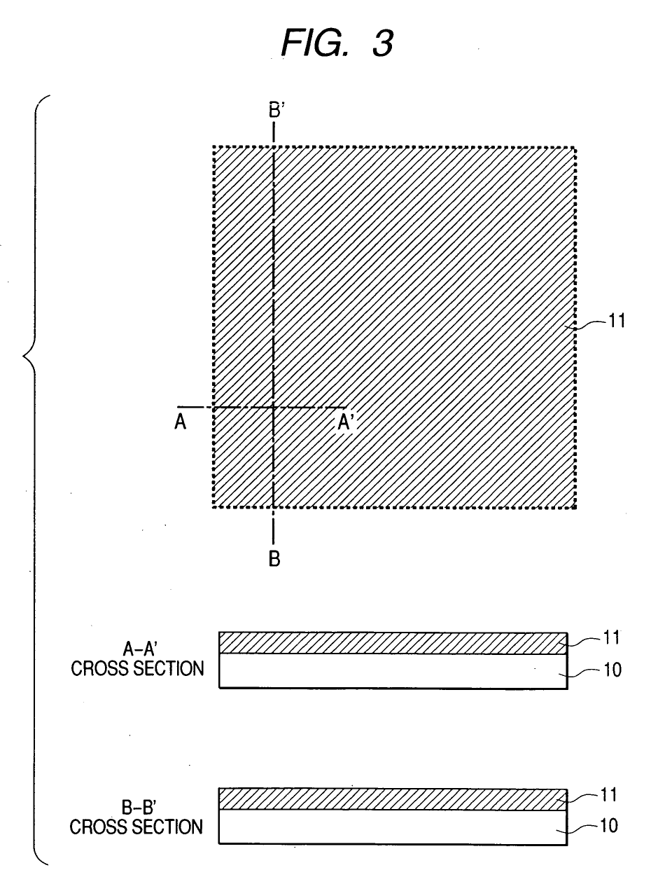

FIG. 2 is a drawing for showing the operating principle of the MIM type electron source. This electron source applies a drive voltage Vd across the upper electrode 13 and the lower electrode 11, and when the electrical field within the tunnel insulation layer 12 reaches approximately 1 to 10 MV per centimeter, electrons within the lower electrode 11 in the vicinity of the Fermi level transmit through the partition barrier due to the tunnel phenomenon, are input as hot electrons to the conduction band of insulation layer 12 functioning as the electron accelerating layer, and flow into the conduction band of the upper electrode 13. Electrons among these hot electrons that possess an energy equal or higher than the work function φ of the upper electrode 13 and that reach the upper electrode 13 surface are emitted into the vacuum.

Returning to FIG. 1, the inner surface of a display side substrate 110 contains a black matrix 120 or in other words a light blocking layer for raising the contrast of the image display, a red fluorescent element 111, a green fluorescent element 112 and a blue fluorescent element 113. The fluorescent elements for example may utilize Y₂O₂S:Eu (p22-B) for the red color, ZnS:Cu, Al(p22-g) for the green color, and ZnS:Ag, Cl (p22-B) for the blue color. A spacer 30 maintains the cathode substrate 10 and the display side substrate 110 at a specified gap. The interior is sealed in a vacuum by a sealing frame (not shown in drawing) on the outer circumference of the display area.

The spacer 30 is installed on the side opposite the electron emitter section on the width side of scanning electrode 21 of cathode substrate 10, so as to be hidden underneath the black matrix 120 of the fluorescent substrate. The lower electrode 11 connects to the signal line drive circuit 50. The scanning electrode 17 functioning as the scanning electrode line connects to the scanning drive circuit 60.

An example of the manufacturing method for the image display apparatus of this invention is described using FIG. 3 through FIG. 12 for the case when doped silicon is used doping for the partition wall.

First of all, as shown in FIG. 3, a metallic film for the lower electrode 11 is deposited on the substrate 10 which is insulated material such as glass. Aluminum is utilized as the material for the lower electrode 11. Aluminum is utilized in order to form a good quality insulation film for the anode (positive) electrode by anodic oxidation. An Al—Nd (aluminum-neodymium) alloy doped with neodymium (Nd) at 2 percent atomic weight was utilized here. The film was deposited to a thickness of 600 nm for example by the sputtering method.

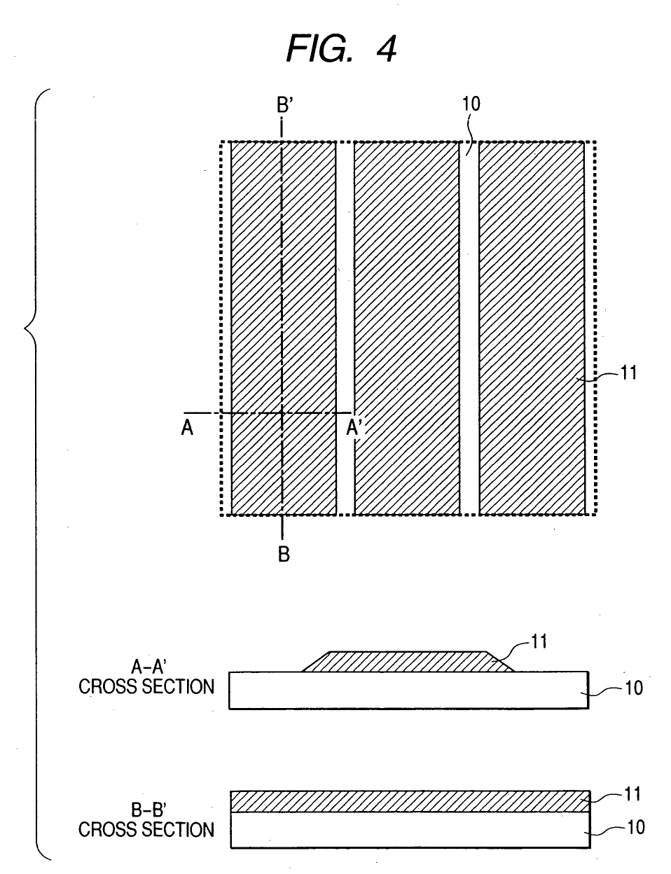

After forming the film, the lower electrode 11 was formed in a stripe shape by a patterning process and an etching process and a patterning process (FIG. 4). This stripe shape is a signal line in the image display apparatus of this invention. The width of the lower electrode 11 varies according to the size and resolution of the image display device but the extent of pitch of the sub-pixels is roughly 100 to 200 microns (μm). The etching process may for example utilize a mixed solution of phosphoric acid, acetic acid and nitric acid for wet etching. This electrode is a simple stripe structure with a broad width so inexpensive proximity exposure methods and print methods can be used for the resist patterning.

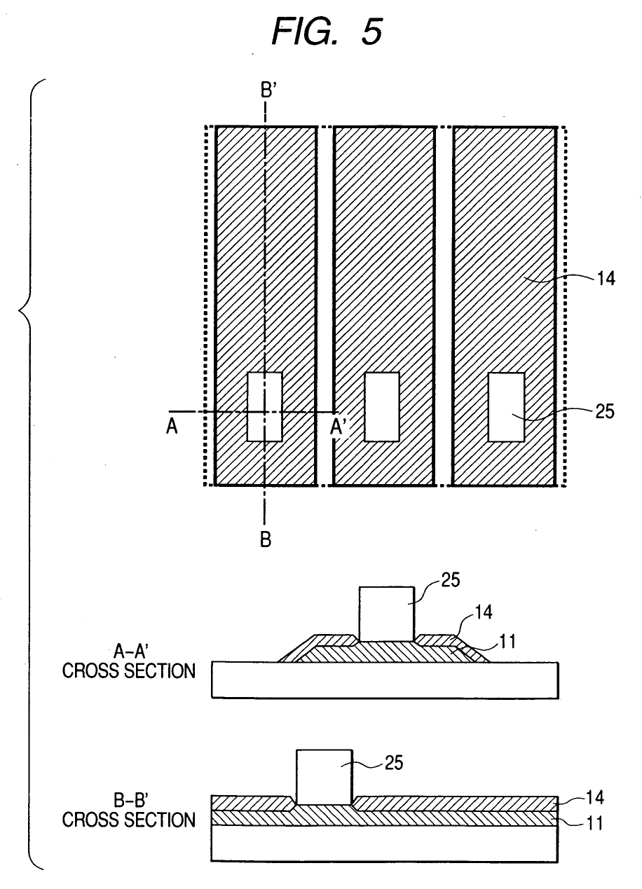

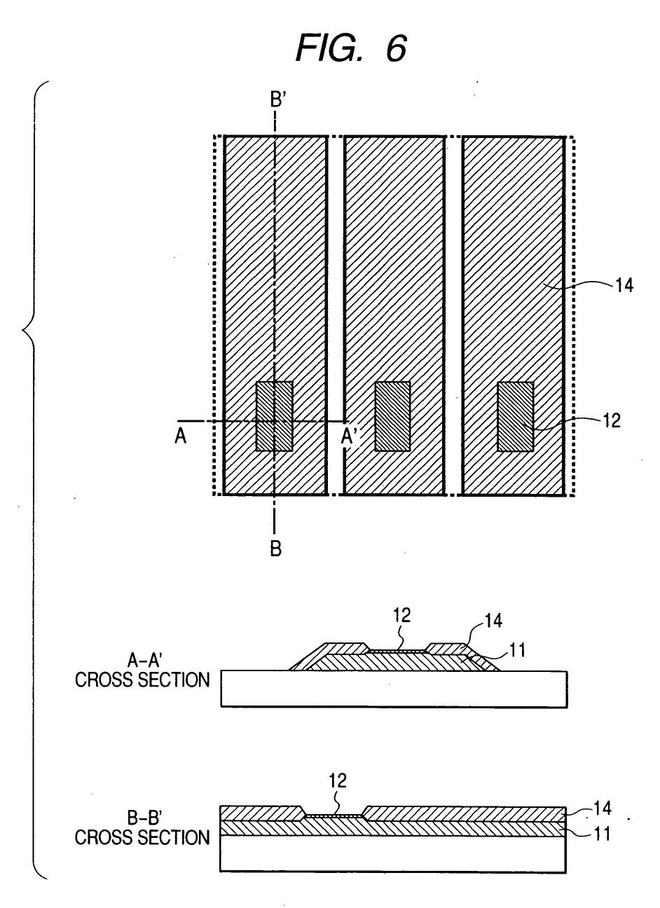

An insulation layer 12 and a protective insulation layer 14 are formed next to prevent an electrical field from accumulating at the edge of the lower electrode 11 and to limit the electron emitter section. The section forming the electron emitter section on the lower electrode 11 is first of all masked with a resist film 25 as shown in FIG. 5, the protective insulation layer 14 is selectively formed thickly on the other sections by anodic for anode oxidization. Applying a forming voltage of 200 volts will form a protective insulation layer 14 with a thickness of approximately 270 nm. The resist film 25 is then stripped off and the remaining surface of the lower electrode 11 is an oxidized by anodic oxidationanode. Applying a forming voltage of 6 volts will form an insulation layer (tunnel insulation layer) 12 to a thickness of approximately 10 nm on the lower electrode 11 (FIG. 6).

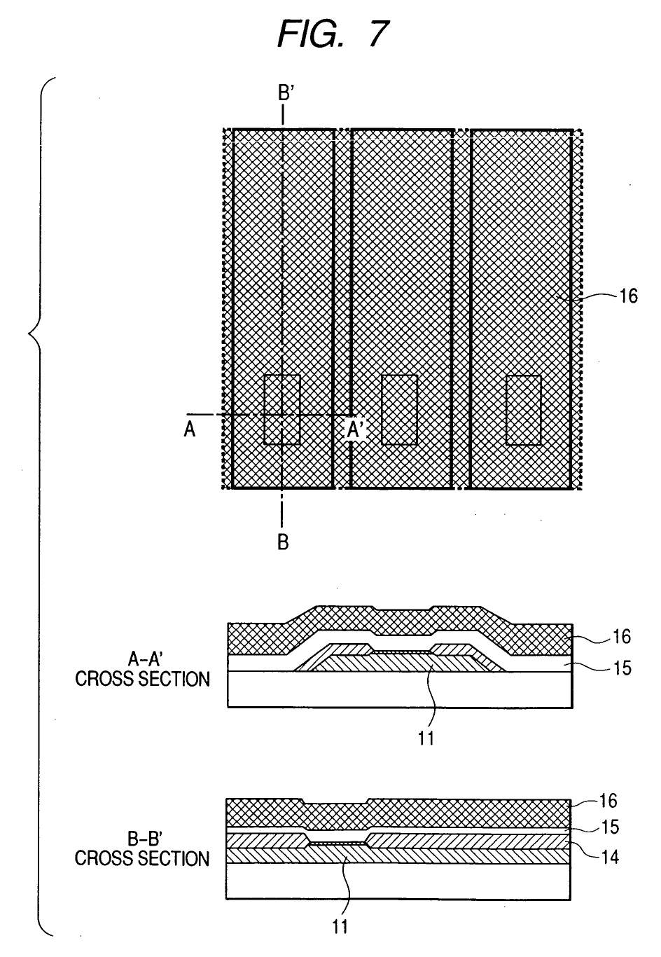

Next an interlayer insulation film 15, and silicon forming the partition wall material are formed using the sputtering method (FIG. 7). Silicon oxide compound and silicon nitride film can be utilized if using silicon in the partition wall material for the interlayer insulation film 15. These materials allow selective etching so that the amount of etching of the interlayer insulation film 15, will be small when dry etching the silicon partition wall as described later on. Reactive sputtering was performed here to deposit silicon nitride film SiN to a thickness of 200 nm in an atmosphere of argon and nitrogen. If there were pinholes in the protective insulation layer 14 formed by anode oxidation then the interlayer insulation film 15 had the function of filling in those defects and maintaining the insulation between the lower electrode 11 and the scanning electrode. The silicon for the partition wall material was sputtered utilizing a silicon target doped with boron or phosphorous to form a film to a thickness of 200 nm in an argon atmosphere. The doped silicon (film) form by sputtering was inert and was capable of being utilized as an extremely high resistance semiconductor material when using largely intrinsic semiconductors.

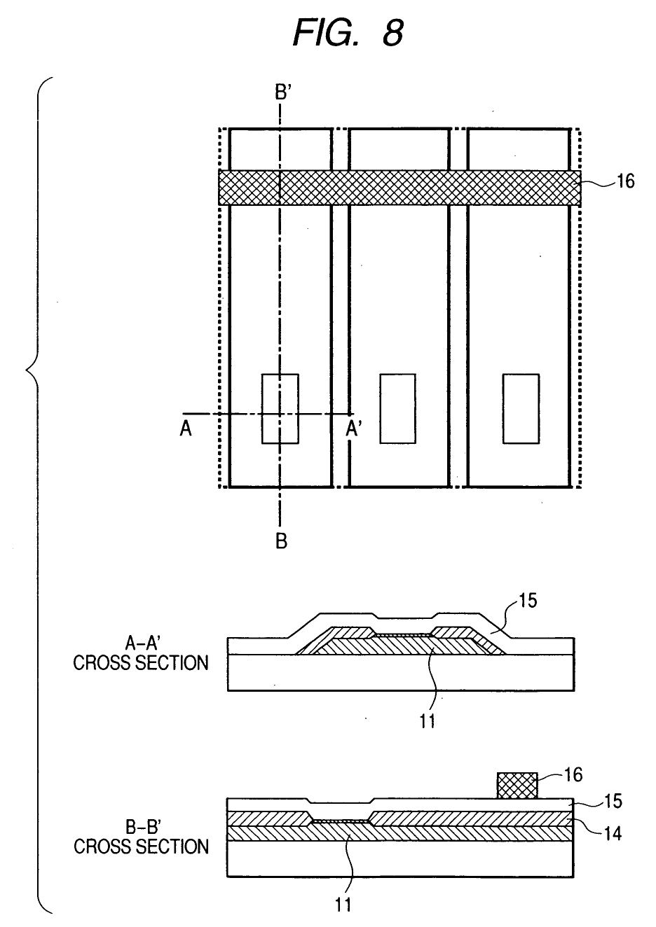

Silicon was next selectively etched on the SiN interlayer insulation film 15 to form the partition wall (FIG. 8) by dry etching. The silicon was selectively dry etched using a gas mixture of CF₄ and O₂, or a gas mixture of SF₆ and O₂. These gases can be used to selectively etch silicon and SiN, however the silicon etching selectivity rate can be raised by optimizing the O₂ ratio.

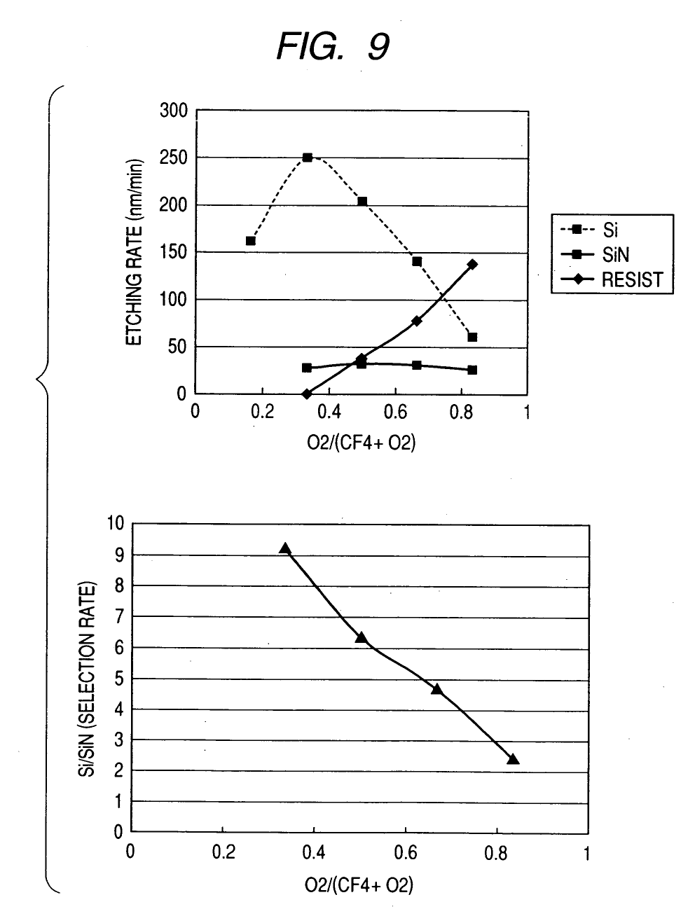

FIG. 9 shows the dependence of silicon and SiN, and resist etching rates on the CF₄ and O₂ gas ratios. The silicon etching speed can be increased to nine times the SiN etching speed by setting an oxygen (O₂) mixture of 30%. The silicon can therefore be selectively etched on the SiN. The etching rate of the resist is approximately zero at this mixture rate, and a silicon partition wall 16 can be formed with an extremely steep side wall with no recession in the resist during etching. The etching speed when using silicon oxide or silicon oxynitride oxide-nitride on the interlayer insulation film 15 is lower than the etching speed when using silicon nitride so that higher selectivity can be obtained. Forming the side wall of the partition steeper than scanning electrode 17 and the interlayer insulation film 15 makes it easy to cut the side wall partition layers for the electron emitter electrode later on so that cutting layers for other section can be made more difficult.

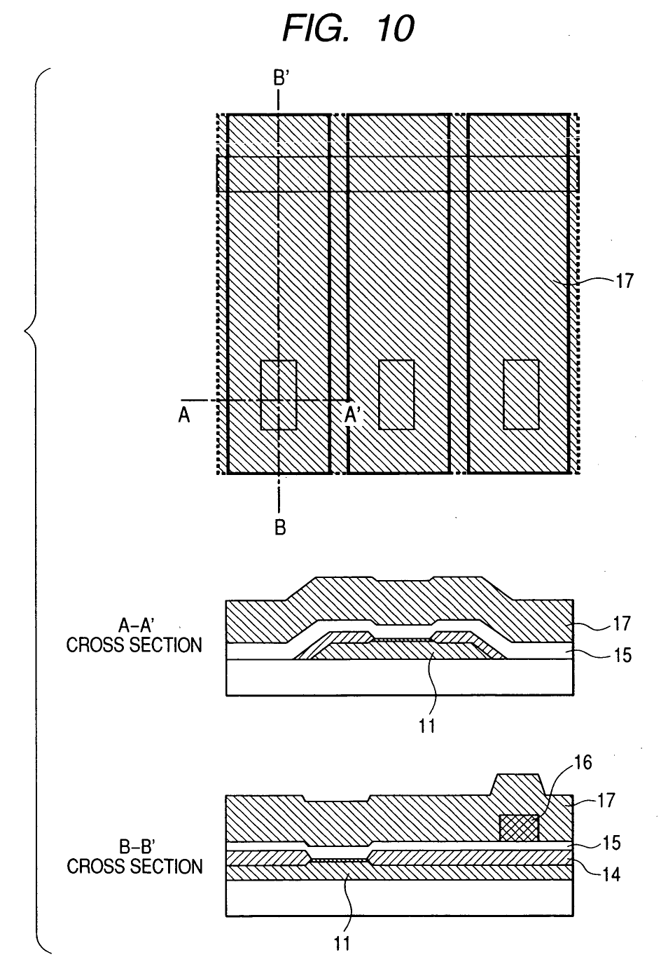

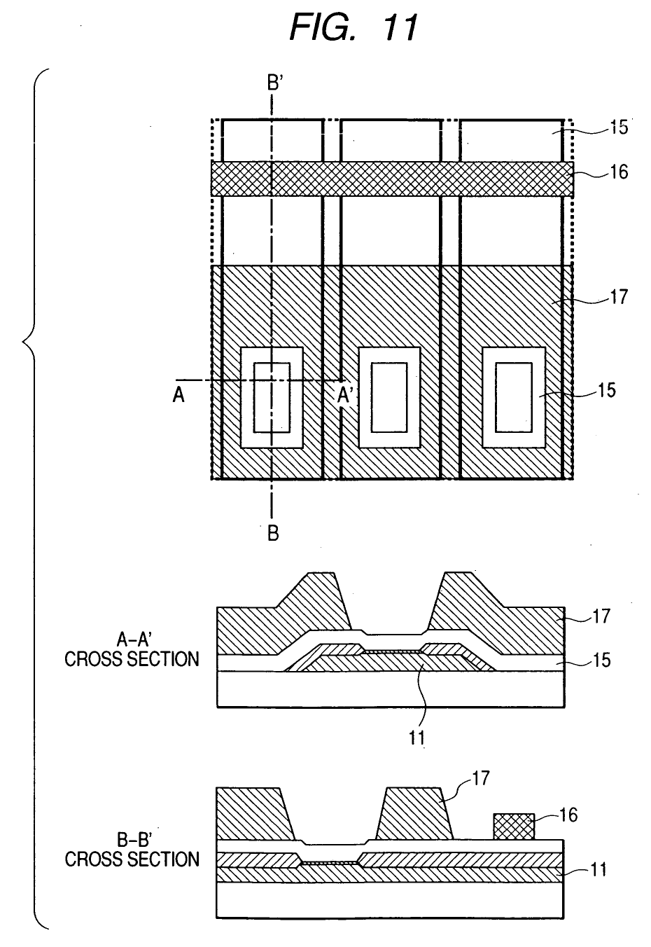

The supply line for the electron emitter electrode, and in the case of the image display apparatus of this embodiment, the aluminum film functioning as the scanning electrode are formed by sputtering to a thickness of 4.5 um (FIG. 10), made to cross the lower electrode 11 by the hot photoetching process, to form a scanning electrode 17 with the electron emitter section formed with an opening nearer one side along the width within the electrode. Etching may be performed by wet etching with a liquid mixture for example of phosphoric acid, acetic acid, and phosphoric acid (FIG. 11). The supply electrode is formed with a taper to connect without cutting the electron emitter electrode. The taper angle formed with the interlayer insulation film is formed smaller than the taper angle formed by the partition wall and interlayer insulation film. The aluminum or aluminum alloy can easily be formed with a taper by lowering the resist edge bonding (adhesiveness) by adjusting the ratios of phosphoric acid, acetic acid and nitric acid of the etching solution or more specifically increasing the percentage of nitric acid. The acid resistance of aluminum to high temperature oxidation is high so this processing is most satisfactory as the scanning line material for the image display apparatus of this invention.

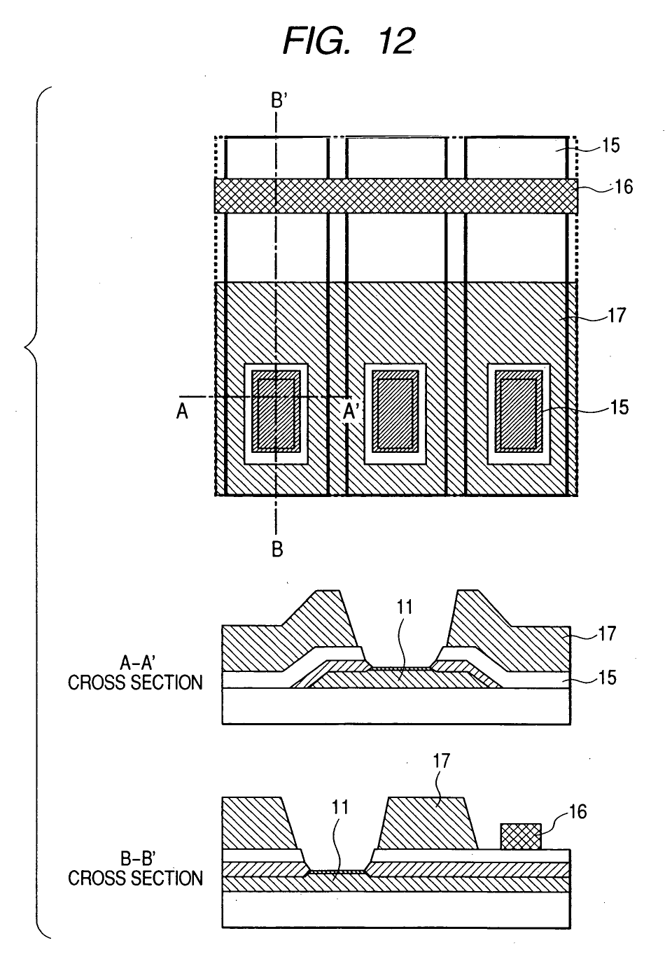

Next, the interlayer insulation film 15 is processed, forming an electron emitter section opening. The electron emitter section is formed in one section intersecting a space enclosed by one lower electrode 11 within the pixel, and two scanning electrodes intersecting the lower electrode 11. Etching can be performed by dry etching with an etching gas solution utilizing for example CF₄ and SF₆ as the main ingredients (FIG. 12).

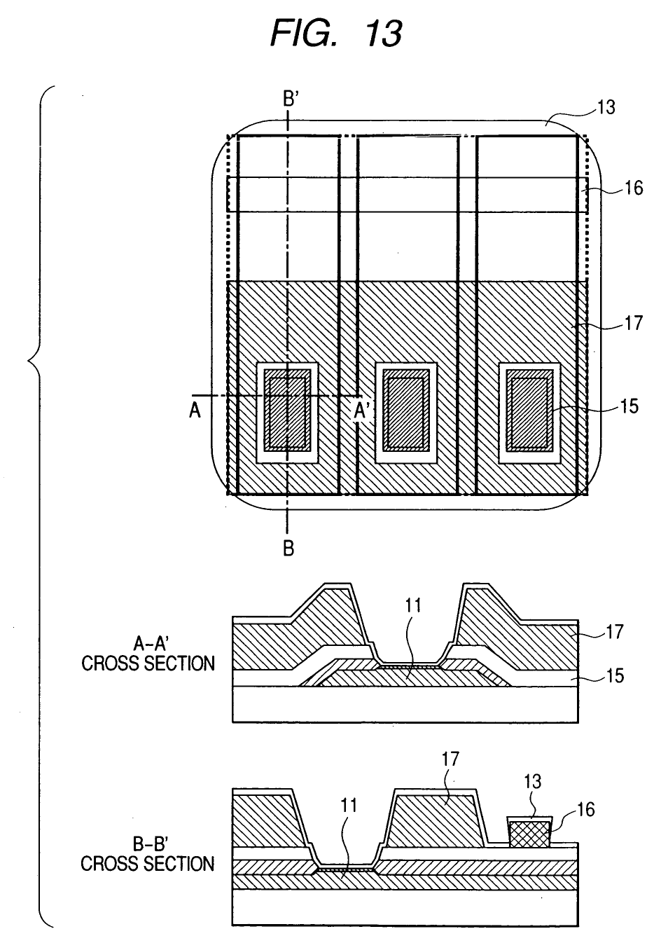

The electron emitter electrode 13 film is formed next. This film is formed for example by sputtering. The upper electrode 13 is formed to a thickness for example of 3 nm utilizing a laminated film of iridium (Ir), platinum (Pt), and gold (Au) (FIG. 13).

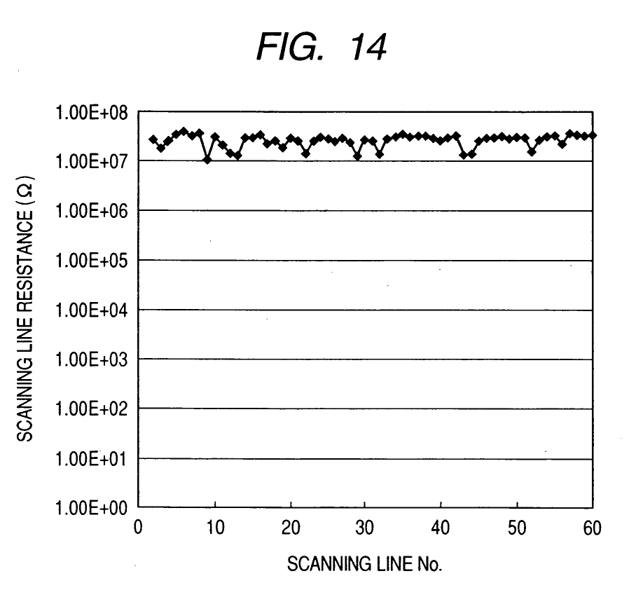

In the case of the thin electron emitter electrode 13 as described above, due to the steep step difference in the silicon side wall as shown in FIG. 14, the step is cut at the stage that the electron emitter electrode is formed, and a resistance of 20 MΩ is obtained across each scanning line (upper threshold of measurement device accuracy) so that the electron emitter electrodes are isolated into individual scanning lines at a resistance value sufficient to prevent crosstalk from occurring during image display.

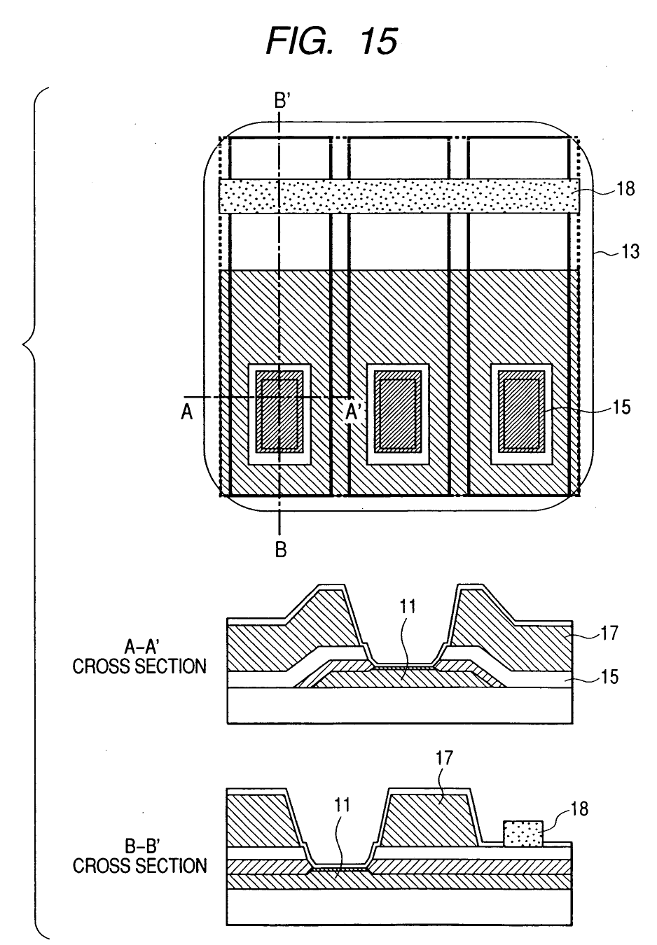

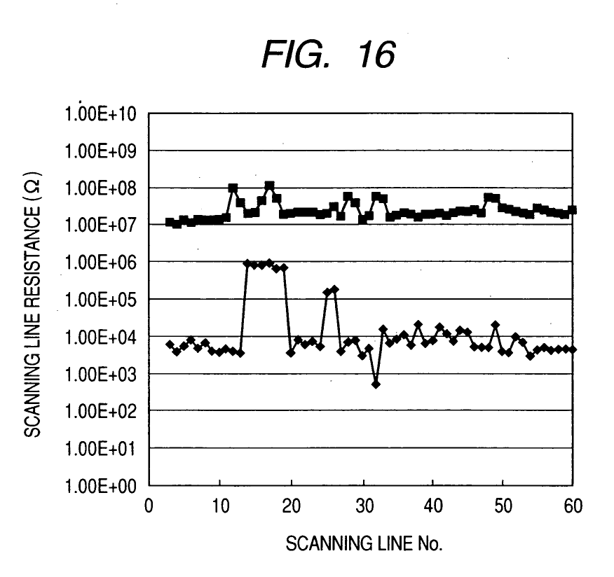

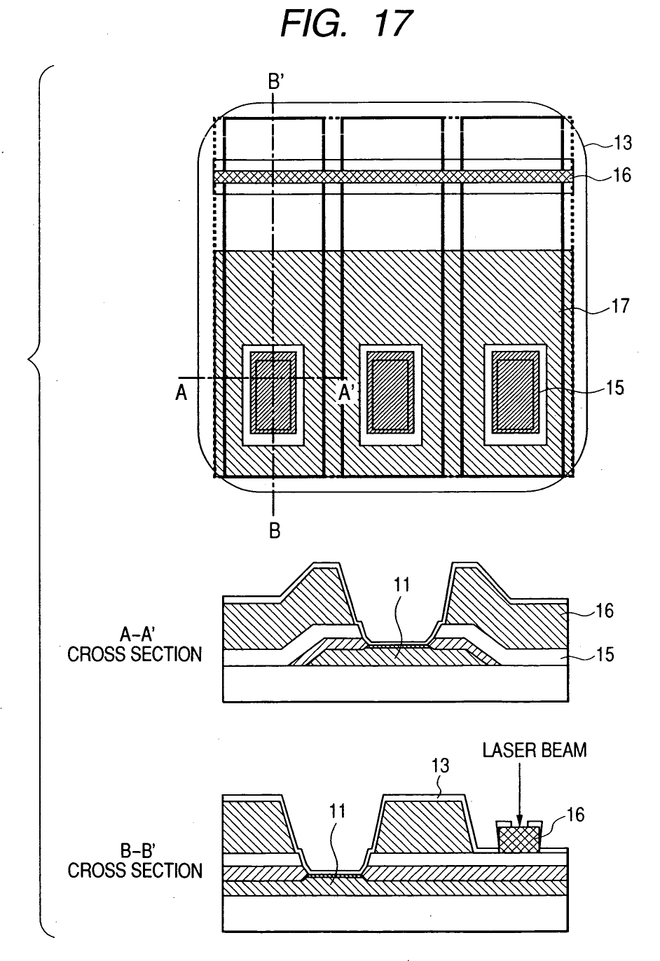

When utilizing for example a laminated film of iridium (Ir), platinum (Pt), and gold (Au) set to a film thickness of 6 nm that is thicker than the above electron emitter electrode, there is good attachment coverage to the partition wall so that the individual scanning lines cannot be completely isolated in the film forming stage. However heating the partition wall silicon dissolves many rare earth noble metals and transition metals, inducing siliciding, and moreover causes the SiO₂ film to develop further due to oxidation from the heating so that it becomes non-conductive after panellization heat treatment and the electron emitter electrode can be electrically isolated into individual scanning lines. This structure is shown in FIG. 15 (reference numeral 18 is the partition wall after heating and siliciding), and the change in resistance between pixels is shown in FIG. 16. Though the resistance across the scanning electrodes was approximately 10 kΩ prior to the heat treatment, a resistance of 20 MΩ (upper threshold of measurement device accuracy) was obtained after heat treatment. So that isolating the electron emitter electrodes at this resistance value is sufficient to prevent cross talk from occurring during an actual image display.

Another method different from the above pixel isolation method is to irradiate the partition wall 16 with a laser beam as shown in FIG. 17, to cut the electron emitter electrode 13 by ablation caused by heating the surface of the partition wall 16. Using silicon in particular as the partition wall 16 raises the heat absorption efficiency and helps prevent damage to the lower electrode 11 and the interlayer insulation film 15 underlayers. This process can be utilizing on the entire substrate for isolating pixels but the processing (or machining) requires some time, so using it for correcting isolation defect locations proves more effective.

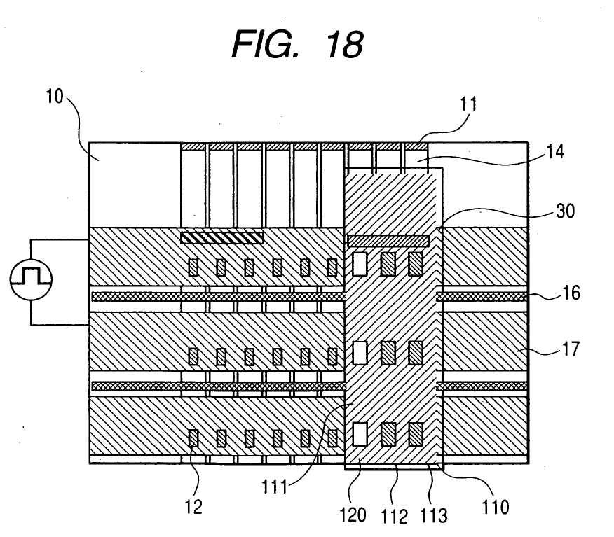

Yet another isolation method is applying a voltage across the scanning electrode 17 on both sides of partition wall 16 as shown in FIG. 18, and then conducting electricity to the electron emitter electrode 13 to thermally cut the electron emitter electrode 13 by Joule's heat. The electron emitter electrode 13 does not adhere on the side wall of the partition wall 16 and resistance is high so that thermal cutting is easy. This method selectively applies a voltage only across the electrically shorted scanning electrode 17 and so is also effective for correcting isolation (defect) locations. In cases where the fluorescent board was already assembled into the panel, making corrections by laser is impossible so this method proves particularly effective.

The above methods are simple techniques that allow separating the electron emitter electrode into individual scanning lines and also reduce the process costs. These methods are also effective for corrective defective pixel isolation locations.

Silicon was used as the partition wall in the above description. However when SiN is used as the partition wall, then dry etching can be selectively performed if the interlayer insulation film is silicon oxide or silicon oxynitride oxide/nitride. The siliciding reaction will not occur during the heat treatment if SiN was utilized, but the irregularities on the side wall of the SiN partition that was dry etched are rough compared to the film-formed surface, so after heat treatment the electron emitter electrode condenses, forming electrically non-conductive island shapes and therefore isolation can be achieved by heat treatment the same as when using a silicon partition wall.

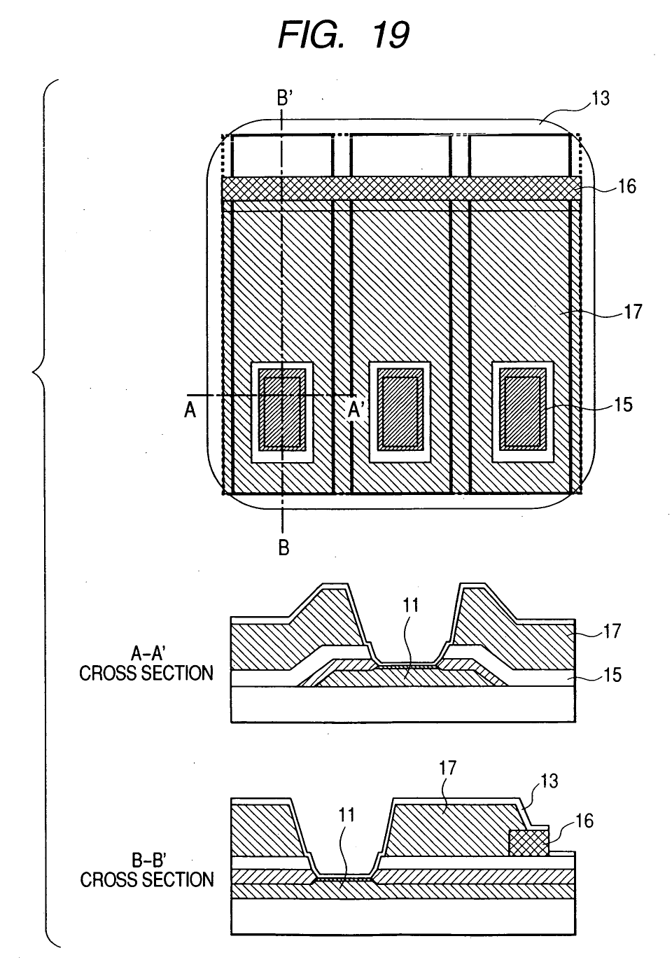

The partition wall in this embodiment was formed between the scanning lines with both side surfaces exposed. However exposing one side is sufficient for isolating the electron emitter electrodes. A structure as shown in FIG. 19 is therefore adequate. This structure is effective in reducing the amount of exposed insulation film on the surface of the partition wall, suppressing electrostatic charges within the panel, and preventing abnormalities such as discharges across the cathode substrate and fluorescent substrate.

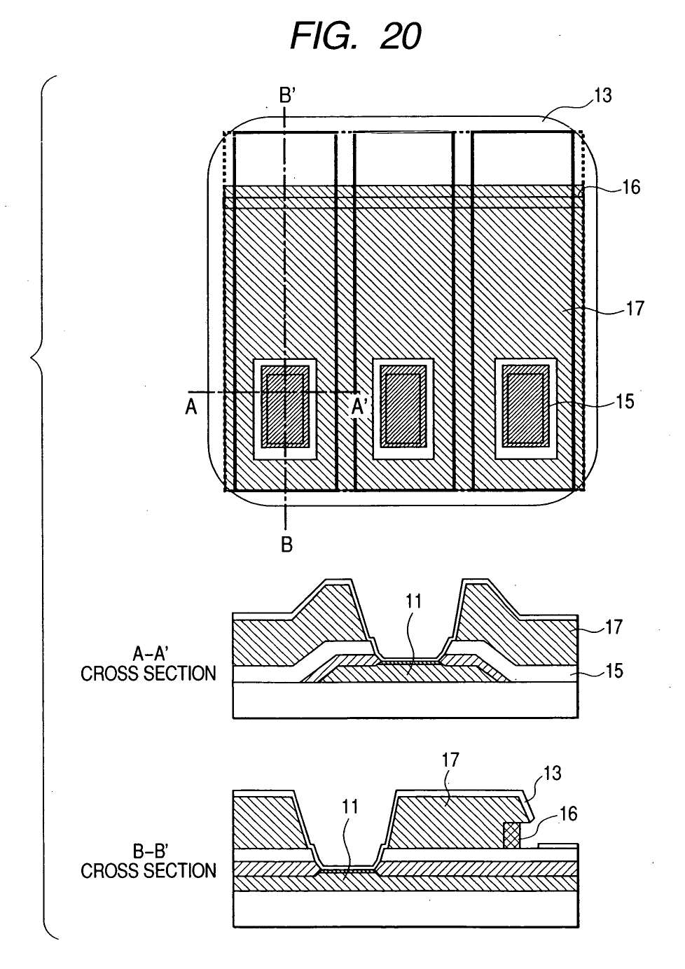

In the structure of FIG. 19, the silicon partition wall 15 can be side-etched using the scanning electrode 17 as a mask, during dry etching of the silicon partition wall 16. An undercut can be formed on one side surface of the scanning electrode 17 as shown in FIG. 20. In this case, one side of the scanning electrode 17 forms an overhang when forming the film for the upper electrode 13. The electron emitter electrodes can be isolated (separated) via self alignment because the undercut section is masked and no film formed for the upper electrode 13. This structure yields the advantage that the side surface of the undercut is an insulated piece so that electrical shorts do not tend to occur compared to the case when an undercut is formed on the side wall of the supply electrode.

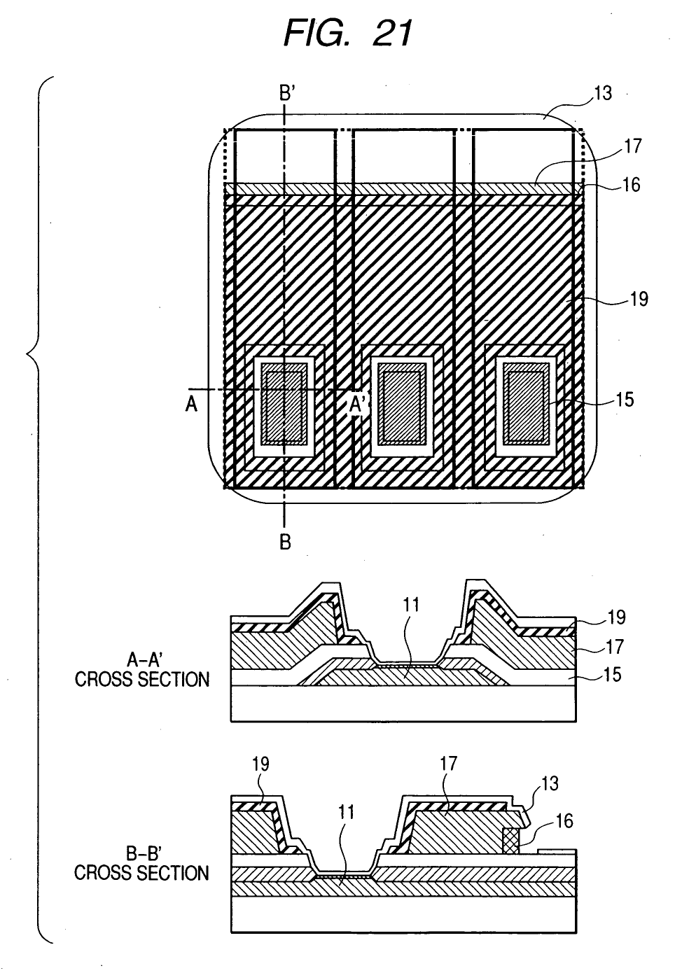

When forming the above described undercut, the overhang tends to lack strength when forming a taper on the scanning electrode. A scanning electrode possessing a dual layer structure may be thereupon be utilized such as shown in FIG. 21, made up of a scanning electrode 17 with a thick film and large taper angle as the lower layer, and a connector electrode 19 processed to a taper shape, covered on the electron emitter section side but not covered on the isolated side, as the upper layer.

What is claimed is:

1. An image display apparatus including an electron source array containing thin film electron emitter electrodes for emitting electrons from an electron emitter electrode, and a fluorescent surface installed facing the electron source array,
wherein an insulation partition wall is formed on the same layer and parallel to the supply electrode, between multiple supply electrodes for supplying power to the electron emitter electrodes, installed parallel to and at the same height on the interlayer insulation film laminated on the signal electrode, and
wherein the electron emitter electrodes formed across the entire surface of the image display are electrically isolated by the partition wall into individual supply electrodes.

2. The image display apparatus according to claim 1,
wherein the partition wall material is an insulating element or an insulated semiconductor.

3. The image display apparatus according to claim 2,
wherein the insulating element of the partition wall material is silicon nitride.

4. The image display apparatus according to claim 2,
wherein the partition wall material for the insulated semiconductor is an intrinsic semiconductor, or is an inactive impurity-doped semiconductor.

5. The image display apparatus according to claim 4,
wherein the insulated semiconductor is non-doped silicon or is insulated silicon doped with inert boron or phosphorous.

6. The image display apparatus according to claim 3,
wherein the underlayer for the partition wall of silicon nitride functioning as the interlayer insulation film is silicon oxide, or silicon oxynitride.

7. The image display apparatus according to claim 5,
wherein the underlayer for the partition wall of silicon functioning as the interlayer insulation film is silicon nitride, silicon oxide, or silicon oxynitride.

8. The image display apparatus according to claim 1,
wherein the partition wall is isolated from a supply electrode adjacent on one side, connected to the other supply electrode, and only the side surface of the partition wall is exposed.

9. The image display apparatus according to claim 1,
wherein the partition wall is isolated from a supply electrode adjacent on one side, is covered at the other supply electrode, and forms an undercut on the side surface of that other supply electrode.

10. The image display apparatus according to claim 1,
wherein the supply electrode is tapered relative to the interlayer isolation film surface.

11. The image display apparatus according to claim 9,
wherein the supply electrode is a two-layer structure including a thin upper layer with a small taper angle to the interlayer insulation film surface covering one side surface of a thick lower layer with a large taper angle; and power is supplied from the side with the small taper angle, and an undercut is formed on the side surface with the large taper angle.

12. The image display apparatus according to claim 1,
wherein the taper angle of partition side wall surface on the interlayer insulation film surface the interlayer insulation film surface on the partition side wall surface is a larger taper angle than the supply electrode on the interlayer insulation film on the supply electrode.

13. The image display apparatus according to claim 1,
wherein the supply electrode is aluminum or is an aluminum alloy containing aluminum as the main element.

14. The manufacturing method for an image display apparatus according to claim 1,
wherein the partition wall is selectively etched and formed by dry etching on the interlayer insulation film.

15. The manufacturing method for an image display apparatus according to claim 1,
wherein the supply electrodes electrically isolated on both sides of the partition wall by severing the electron emitter electrodes by utilizing the steep step differential of the partition wall.

16. The manufacturing method for an image display apparatus according to claim 1,
wherein the supply electrodes are electrically isolated on both sides of the partition wall by using heat treatment to condense the surface of the partition wall.

17. The manufacturing method for an image display apparatus according to claim 1,
wherein the supply electrodes are electrically isolated on both sides of the partition wall by causing a phase transformation reaction in the electron emitter electrodes with the silicon partition wall by heat treatment to cause absorption diffusion.

18. The manufacturing method and wiring correction method for an image display apparatus according to claim 1,
wherein the supply electrodes are electrically isolated on both sides of the partition wall by electrical conduction by applying a voltage across two supply electrodes interposed between a partition wall and, thermally cutting the high resistance section of the electron emitter electrode of the partition wall overhang by Joule's heat.

19. The manufacturing method and wiring correction method for an image display apparatus according to claim 1,
wherein each of the supply electrodes are electrically isolated by irradiating a laser beam onto the electron emitter electrodes on the partition wall and, thermally cutting the electron emitter electrodes by ablation.
